(19) United States
(12) Patent Application Publication
(10) Pub. No.: US 2017/0308980 A1
(43) Pub. Date: Oct. 26, 2017

(54) MATCHING CANDIDATE STUDENT LEADS TO SCHOOL DEMOGRAPHIC PREFERENCES

(71) Applicant: Chegg, Inc., Santa Clara, CA (US)

(72) Inventors: Rahul Ravindra Mutalik Desai, San Jose, CA (US); Fei Sha, Santa Clara, CA (US); Ben Van Roo, Santa Clara, CA (US); Seth Kadish, Santa Clara, CA (US); Dax Eckenberg, Los Gatos, CA (US); Michael Osier, Santa Clara, CA (US); Jason Schnitzer, Santa Clara, CA (US)

(21) Appl. No.: 15/134,311

(22) Filed: Apr. 20, 2016

(51) Int. Cl. G06Q 50/20; G06F 17/30; G06Q 10/10

(52) U.S. Cl. CPC G06Q 50/2053; G06Q 10/10; G06F 17/3053; G06F 17/30867

(57) ABSTRACT

A lead matching system selects and ranks candidate leads for school admissions officers. The system records personal and academic information for each candidate as well as expressions of interest from that candidate toward one or more schools. The system also records information describing each school, such as its academic profile, location, class size, athletic program quality, and so on. The system also records each school's immediate demographic preferences for an incoming class of students. The system analyzes candidate and school information to generate a set of scored candidate leads. The system then identifies a subset of leads for each school based on its demographic preferences, and ranks the leads. The system provides a subset of ranked leads to each school.

### BACKGROUND

This invention relates generally to educational recruiting, and more particularly to identifying and matching candidate leads based on school requirements.

### SUMMARY

A lead matching system improves the efficiency of school admissions by providing a set of ranked, scored leads for each participating school. A lead indicates a candidate of potential interest to a participating school. The system records information describing each candidate, such as his/her personal information, academic record, extracurricular activities, and so on. The system also records actions performed by a candidate which indicate his/her interest in one or more schools. The system also records information describing each participating school, such as its class size, academic record, fields of study, quality of athletics, culture, and so on. The system applies a collaborative filtering technique in which it identifies similarities between candidates and uses candidates' expressed interests to infer interest between other candidates and schools. The system then produces for each school a selected subset of candidate leads by recording the school's particular demographic preferences for its incoming class. The demographic preferences describe qualities or traits preferred by the school for students in the incoming class. The system identifies a subset of leads which are consistent with the school's demographic preferences. The system transmits this subset of leads to the school for use as part of its admissions process.

### BRIEF DESCRIPTION OF THE DRAWINGS

FIG. 1 illustrates the environment of an online admissions platform, according to one embodiment.

FIG. 2 is a diagram of a lead matching system, according to one embodiment.

FIG. 3 is a chart illustrating the prediction of candidate interest based on expressed interests, according to one embodiment.

FIG. 4A is a diagram illustrating expressions of interest between candidates and schools, according to one embodiment.

FIG. 4B is a diagram illustrating inferred interest between candidates and schools, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Environment of an Online Admissions Platform

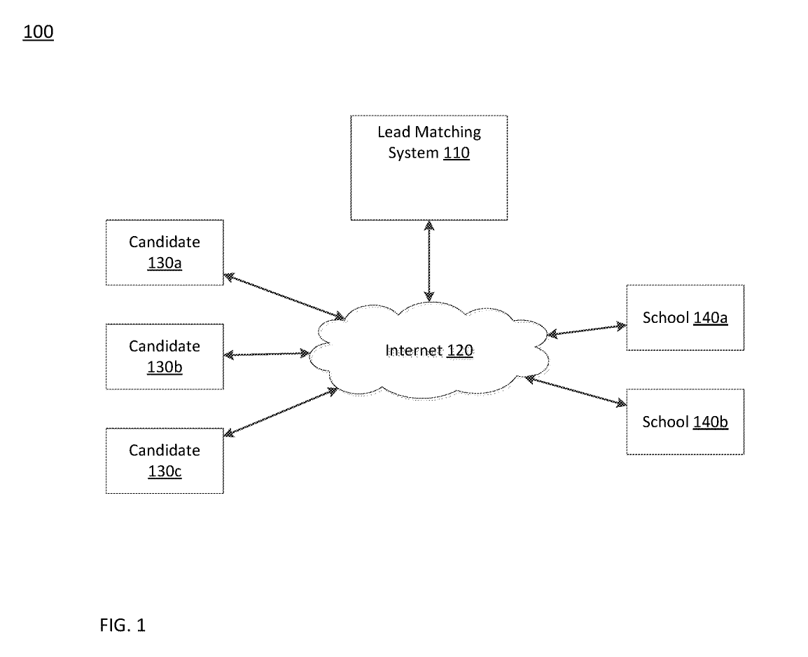

FIG. 1 is a diagram illustrating the environment of an online admissions platform, according to one embodiment. The environment 100 of the platform includes a lead matching system 110. The lead matching system 110 includes both a business-to-consumer (B2C) and business-to-business (B2B) components and is configured to identify candidate leads for participating schools (as will be described in detail later). The lead matching system 110 is connected via the Internet 120 to candidates 130 and schools 140. The lead matching system 110 is also connected via the Internet 120 to schools 140. Candidates 130a, 130b, and 130c and schools 140a and 140b are purely for example; the lead matching system 110 could simultaneously support thousands or even millions of candidates 130 and hundreds or thousands of schools 140.

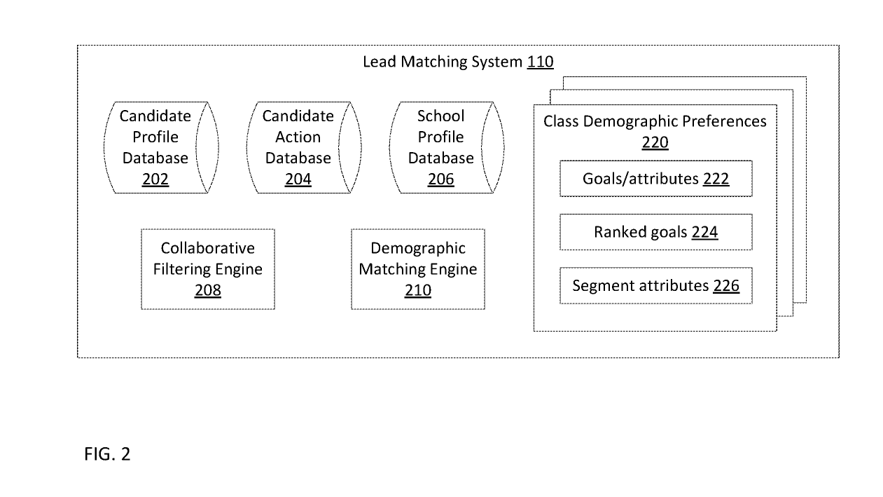

FIG. 2 is a diagram of a lead matching system 110, according to one embodiment. The system 110 is configured to identify, match, and rank candidate leads for use by school admissions groups. The system 110 includes a candidate profile database 202 that is configured to store a collection of candidate profiles. Each candidate profile is a compilation of information pertaining to a particular candidate 130. This information could be personal (location, race, gender, etc.) or academic (previously completed courses, grades, academic interests, etc.). In one embodiment, each candidate profile is composed from information inputted by a candidate 130 himself via an online recruiting platform.

The system 110 includes a candidate actions database 204 that is configured to store a record of candidate actions. In some embodiments, candidate actions include an expression of interest made by a candidate 130 toward a particular school 140. The expression of interest could be expressed as a like, comment, or subscription (for example, to an RSS feed) made in the context of an online recruiting platform. In one embodiment, the candidate profile database 202 and candidate action database 204 are consolidated into a single database.

The lead matching system 110 further includes a school profile database 206 that is configured to store a collection of school profiles. Each school profile contains information describing a participating school, such as its location, selectivity, class size, disciplines/degrees offered, athletic programs, and so on. In one embodiment, a school profile includes information entered by a school administrator or admissions officer via an interface of the online platform. School profile information may also be compiled or aggregated from sources that are publicly available on the Internet, such as on forums, blogs, and other websites.

The lead matching system 110 further includes a collaborative filtering engine 208. The engine 208 accesses and synthesizes information from each of the databases 202, 204, and 206 to determine a set of scored leads. Each scored lead expresses a potential affinity between a candidate 130 and a school 140. In some embodiments, the potential affinity is expressed in quantitative terms, such as with a numerical suitability rating. For example, the rating may run from 0 (indicating complete unsuitability between the user 130 and the school 140) to 100 (indicating a near-perfect match between a user 130 and a school 140). In one embodiment, the collaborative filter engine 208 produces at least one scored lead for each candidate 130.

The lead matching system 110 includes a demographic matching engine 210. The demographic matching engine 210 is configured to further process the set of scored leads outputted by the collaborative filtering engine 208 in order to determine the most suitable subset of the scored leads for each school 140. The most suitable subset for each school 140 is determined based on a set of class demographic preferences 220. A set of class demographic preferences 220 is provided (either periodically or upon request) by a school 140, and describes the preferences of the school 140 for its incoming class. In one embodiment, the class demographic preferences 220 include goals/attributes 222, ranked goals 224, and segment attributes 226. Goals/attributes 222 describe desired attributes, requirements or criteria relating to the incoming class (e.g., at least 35% of the class should belong to a middle-income family). Ranked goals 224 describe the relative important of various attributes (e.g., an under-represented minority candidate is more desirable than a candidate who wants to play on the football team). Segment attributes 226 describe attributes pertaining to a segment of the incoming class. These components are purely for the sake of example; a set of class demographic preferences 220 could include entirely different components.

In one embodiment, the class demographic preferences 220 are further informed or contextualized by school profile information stored in the school profiles database 206. The demographic matching engine 230 may access or retrieve some or all of a school profile from the database 206 as part of processing the class demographic preferences 220.

In some embodiments, the demographic matching engine 210 processes each scored lead by comparing the associated candidate 130 against the class demographic preferences 220 provided by the school 140. Specifically, the demographic matching engine 210 may select leads based on a weighted system in which a candidate 130 receives a point if he/she meets one of the school's stated demographic preferences 220, and no points if he/she does not. In order to make this determination, the engine 210 retrieves candidate profile information from the candidate profile database 202 (e.g., race, location, GPA, etc.). Ultimately, the demographic matching engine 210 outputs a reduced set of matched leads which it determines are most suitable for the school 140 in view of its class demographic preferences 220. Because each matched lead is associated with a total score, the demographic matching engine 210 further ranks each matched lead in the reduced set. The engine 210 then provides the ranked matched leads to the school 140.

The above process described with reference to FIG. 2 can be performed continuously or periodically, perhaps in response to a request for matched leads from a school 140. In some embodiments, schools 140 will request a set of ranked matched leads in preparation for or during an admissions cycle.

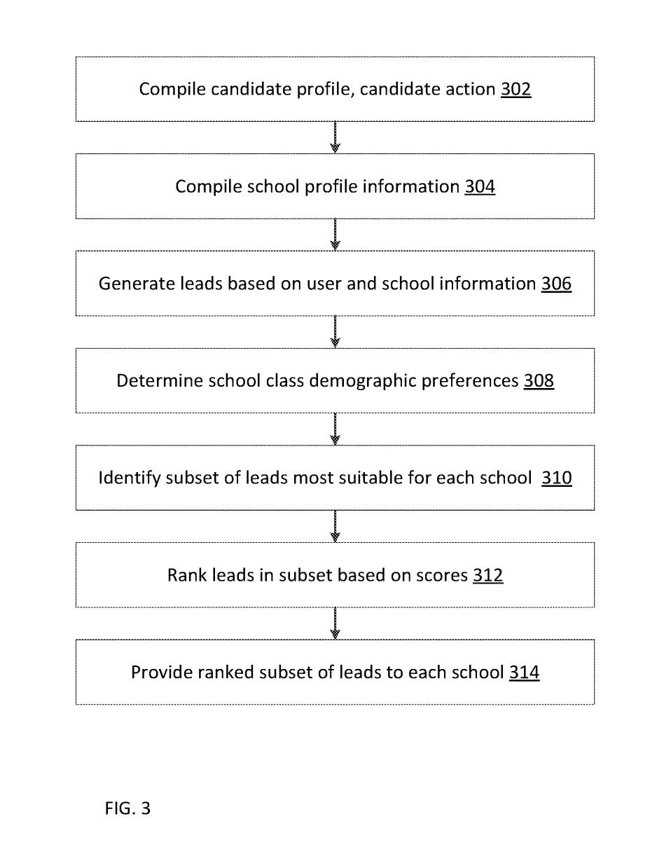

FIG. 3 is a flowchart of a process for determining ranked matched candidate leads, according to one embodiment. The lead matching system compiles 302 a collection of candidate profiles as well as a record of candidate actions. As described previously, a candidate profile and candidate action are compiled based on information provided by or actions performed by each candidate in the context of the online platform. The lead matching system then compiles 304 a collection of school profiles, each school profile describing a particular school. The lead matching system then generates 306 leads based on the candidate and school information. Each lead indicates a potential affinity between a particular candidate and a particular school. The lead also includes a quantitative measure or score, such as a ranking from 0 to 100. The lead matching system then determines 308 a set of class demographic preferences for each school. As described previously, these class demographic preferences describe the school's demographic requirements or criteria for its incoming class. The lead matching system then identifies 310 for each school a subset of the leads that are most suitable for the school based on its class demographic preferences. The system then ranks 312 each lead in each subset based on the lead score. Finally, the system provides 314 a ranked subset of leads to each school.

### Collaborative Filtering Based on Expressed Interest

As described previously, the lead matching system 110 performs collaborative filtering to infer candidates' interest in schools. Candidates 130 may express interest in one or more schools 140. The lead matching system 110 compares candidates 130 and schools 140 against each other and amongst themselves. The lead matching system 110 uses expressions of interest to determine whether a candidate 130 may be interested in—or suitable for—a particular school 140 even if he/she has not explicitly expressed interest in the school. The lead matching system 110 can then recommend the school 140 to the candidate, and vice versa, for the purpose of admissions.

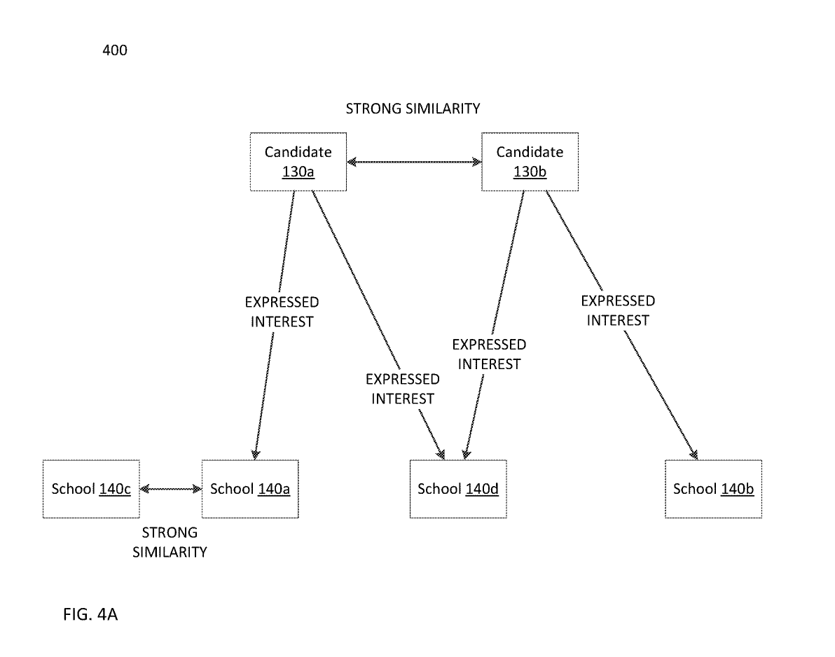

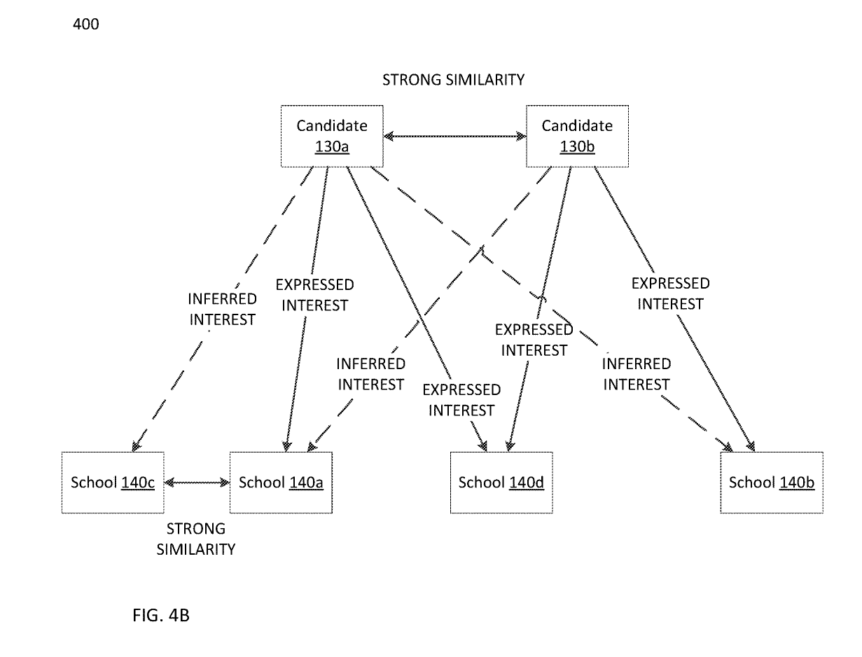

FIG. 4A is a diagram illustrating expressions of interest between candidates and schools, according to one embodiment. The environment 400 includes two candidates 130a and 130b. The lead matching system 110 identifies these candidates as being strongly similar. The environment 400 also includes four schools 140a, 140b, 140c, and 140d. Additionally, the lead matching system 110 identifies schools 140a and 140c as being strongly similar. Connections between a candidate and a school indicate an expression of interest by the candidate toward the school. In the example of FIG. 4A, candidate 130a expresses interest in schools 140a and 140d. Candidate 130b expresses interest in schools 140b and 140d.

As described previously, the lead matching system 110 processes explicit expressions to infer, for one or more candidates, interest in one or more schools. In a typical embodiment, the lead matching system 110 employs a method of collaborative filtering in which a candidate's interest in a school is inferred based on its similarity to other candidate(s) with known interests.

In one embodiment, the lead matching system 110 infers interest by expressing each candidate 130, and each school 140, in quantitative terms. For example, the lead matching system represents each entity as a feature vector composed of multiple components. The lead matching system may then perform mathematical operations on the feature vectors to determine similarities between candidates 130, as well as between schools 140. In one embodiment, the lead matching system 110 may define a maximum vector distance; if the distance between two vectors (each vector representing a different candidate 130) is less than the maximum vector distance, then the lead matching system 110 identifies the candidates 130 as similar. The lead matching system 110 may then automatically infer that the schools toward which candidate 130a has expressed interest are also of interest to candidate 130b.

In another embodiment, the lead matching system 110 applies this same technique by computing the difference between different schools 140. The system 110 determines one or more schools 140 as similar based on their vector similarity. The system 110 then provides some or all of the matched leads identified for one school 140a to another similar school 140b.

FIG. 4B is a diagram illustrating inferred interest between candidates and schools according to one embodiment. Based on an identified similarity between candidates 130a and 130b, the lead matching system 110 infers for candidate 130a an interest in school 140b based on the expression of interest by candidate 130b in school 140b. Likewise, the lead matching system 110 infers for candidate 130b an interest in school 140a based on the expression of interest by candidate 130a in school 140a.

In a related embodiment, the lead matching system 110 may perform an alternative method of collaborative filtering in which the system 110 infers a candidate's interest in a school based on his/her known interest in similar school. Referring again to FIG. 4B, school 140a and 140c are identified by the lead matching system 110 to have strong similarity. The system 110 further identifies candidate 130a as having expressed interest in school 140a. The system 110 therefore infers that candidate 130a is also interested in school 140c. The system 110 subsequently presents candidate 130a to school 140c as a potential lead.

### Matching Leads Based on Class Demographic Preferences

As described previously with reference to FIG. 2, a subset of ranked leads are provided to each school 140 based on class demographic preferences 220 expressed by the school 140. In one embodiment, each lead in the set of matched leads is scored using the class demographic preferences. The lead matching system 110 may define a minimum score threshold; leads with scores below this threshold are discarded. A score is assigned to each lead based on the goals/attributes 222, ranked goals 224, and segment attributes 226 (described previously). Each of these components of the preferences 220 specifies a requirement or preference for a particular quality in a candidate 130. A school 140 may also have various requirements/preferences and may communicate the relative importance of each to the lead matching system 110.

For example, a list of goals/attributes 222 may specify that a school 140 wishes to increase recruitment of under-represented minorities (URMs), but is also be looking to increase the size of its fine arts program. Since a given candidate may meet neither, one, or both of these criteria, the ranked goals 224 further specify that an URM candidate is preferred over a prospective fine arts major.

Once the lead matching system 110 determines a list of matched candidates, it then scores them according to the ranked goals 224. In this example, the following leads are ordered in value from greatest to least: a URM candidate who is also a prospective fine arts major (most valuable); a URM who is not a prospective fine arts major; a non-URM who is a prospective fine arts major; and a non-URM who is not a prospective fine arts major (least valuable).

In more sophisticated implementations, the ranked goal as 224 could specify tens or hundreds of preferences/requirements for an incoming class. The lead matching system 110 awards points to each lead based on which criteria it satisfies. As a result, the lead matching system 110 produces a composite suitability score for each lead; it can then define a minimum threshold (as described previously) and retain only those leads which meet or exceed the minimum score threshold.

### Real-Time Updating of Lead Offerings

In another embodiment, lead matching as previously described is applied in real-time during a school admission process. Instead of provided a static set of matched, scored leads to each school 140, the lead matching system 110 continuously updates and revises its leads based on the changing needs of each school 140. For example, as a particular school 140 progresses through an admissions cycle, it offers admission to candidates 130 in a sequential order. Accepted candidates 130 have a choice to accept and offer (matriculate) or deny it. A candidate's decision is not immediate and is difficult for the school 140 to predict. In one embodiment, the lead matching system 110 receives a notification of a candidate's matriculation decision. Based on the candidate's decision, the lead matching system 110 updates its leads offering accordingly. For example, if a school 140 offers admission to a candidate 130, the candidate's decision to matriculate may cause one or more of the schools' class demographic preferences 220 to be satisfied. This change affects the relative value of all the other leads provided by the lead matching system 110 to the school 140; a candidate 130b similar to the matriculating candidate 130 may now be less desired by the school 140 than a more dissimilar candidate 130c. In this instance, the lead matching system 110 re-computes or updates its leads for the school 140, ensuring that at any given point in the admission process, the matched leads offered to the school 140 are reflective of the school's current class demographic preferences 220.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for producing ranked candidate leads, the method comprising:
compiling, for each candidate of a plurality of candidates, a candidate profile;
compiling, for each school of a plurality of schools, a school profile;
generating, based on the candidate profiles and school profiles, a plurality of leads, each lead expressing a potential affinity between a candidate and a school; and
for each school:
determining one or more demographic preferences of the school,
comparing the demographic preferences of the school to the candidate profiles associated with the leads for the school,
ranking at least a subset of the leads based on the comparison of the demographic preferences of the school to the candidate profiles associated with the leads for the school, and
providing the ranked leads to the school.

2. The method of claim 1, wherein the candidate profile describes personal information pertaining to the candidate, and wherein the candidate profile includes one or more attributes, each attribute describing at least one of:
an academic record of the candidate,
an academic interest of the user, and
an expression of interest in a school.

3. The method of claim 1, wherein generating a plurality of leads further comprises performing collaborative filtering on candidate profiles and school profiles.

4. The method of claim 3, wherein collaborative filtering on candidate profiles comprises:
determining an expression of interest toward a school by one of the candidates;
identifying, based on comparison of candidate profiles, at least one other similar candidate; and
recording, for the at least one other candidate profile, an inferred interest in the school.

5. The method of claim 3, wherein collaborative filtering on school profiles comprises:
determining an expression of interest toward a school by a candidate;
identifying, based on comparison of school profiles, at least one other similar school; and
recording, for the candidate, an inferred interest in the at least one other similar school.

6. The method of claim 1, wherein ranking at least a subset of the leads further comprises performing a pre-filtering process in which at least one of the leads is discarded.

7. A computer program product for producing ranked candidate leads, the computer program product comprising a computer-readable storage medium containing computer program code for:
compiling, for each candidates of a plurality of candidates, a candidate profile;
compiling, for each school of a plurality of schools, a school profile;
generating, based on the candidate profiles and school profiles, a plurality of leads, each lead expressing a potential affinity between a candidate and a school; and
for each school:
determining one or more demographic preferences of the school,
comparing the demographic preference of the school to the candidate profiles associated with the leads for the school,
ranking at least a subset of the leads based on the comparison of the demographic preferences of the school to the candidate profiles associated with the leads for the school, and
providing the ranked leads to the school.

8. The computer program product of claim 7, wherein the candidate profile describes personal information pertaining to the candidate and wherein the candidate profile includes one or more attributes, each attribute describing at least one of:
an academic record of the candidate,
an academic interest of the user, and
an expression of interest in a school.

9. The computer program product of claim 7, wherein generating a plurality of leads further comprises performing collaborative filtering on candidate profiles and school profiles.

10. The method of claim 3, wherein collaborative filtering on candidate profiles comprises:
determining an expression of interest toward a school by one of the candidates;
identifying, based on comparison of candidate profiles, at least one other similar candidate; and
recording, for the at least one other candidate profile, an inferred interest in the school.

11. The computer program product of claim 9, wherein collaborative filtering on school profiles comprises:
determining an expression of interest toward a school by a candidate;
identifying, based on comparison of school profiles, at least one other similar school; and
recording, for the candidate, an inferred interest in the at least one other similar school.

12. The computer program product of claim 7, wherein ranking at least a subset of the leads further comprises performing a pre-filtering process in which at least one of the leads is discarded.

13. A lead matching system for producing ranked candidate leads, the system configured to:
compile, for each candidates of a plurality of candidates, a candidate profile;
compile, for each school of a plurality of schools, a school profile;
generate, based on the candidate profiles and school profiles, a plurality of leads, each lead expressing a potential affinity between a candidate and a school; and
for each school:
determine one or more demographic preferences of the school,
compare the demographic preferences of the school to the candidate profiles associated with the leads for the school,
rank at least a subset of the leads based on the comparison of the demographic preferences of the school to the candidate profiles associated with the leads for the school, and
providing the ranked leads to the school.

14. The system of claim 13, wherein the candidate profile describes personal information pertaining to the candidate and wherein the candidate profile includes one or more attributes, each attribute describing at least one of:
an academic record of the candidate,
an academic interest of the user, and
an expression of interest in a school.

15. The system of claim 13, wherein generating a plurality of leads further comprises performing collaborative filtering on candidate profiles and school profiles.

16. The system of claim 15, wherein collaborative filtering on candidate profiles comprises:
determining an expression of interest toward a school by one of the candidates;
identifying, based on comparison of candidate profiles, at least one other similar candidate; and
recording, for the at least one other candidate profile, an inferred interest in the school.

17. The system of claim 15, wherein collaborative filtering on school profiles comprises:
determining an expression of interest toward a school by a candidate;
identifying, based on comparison of school profiles, at least one other similar school; and
recording, for the candidate, an inferred interest in the at least one other similar school.

18. The system of claim 13, wherein ranking at least a subset of the leads further comprises performing a pre-filtering process in which at least one of the leads is discarded.
